(19) United States
(12) Patent Application Publication
(10) Pub. No.: US 2013/0122254 A1
(43) Pub. Date: May 16, 2013

(54) METHOD FOR MANUFACTURING A PATTERNED LAYER OF COMPRESSIVE STRESS ON A GLASS SUBSTRATE AND THE GLASS SUBSTRATE MANUFACTURING BY THE METHOD

(71) Applicant: NAI-YUE LIANG, Taipei (TW)

(72) Inventor: NAI-YUE LIANG, Taipei (TW)

(21) Appl. No.: 13/294,194

(22) Filed: Nov. 11, 2011

(51) Int. Cl. B32B 33/00; B32B 17/00; C03C 21/00

(52) U.S. Cl. 428/156; 65/30.14; 428/210

(57) ABSTRACT

A method for manufacturing a patterned layer of compressive stress on a glass substrate includes forming a mask having predetermined pattern on a surface of the glass substrate. The pattern includes a plurality of hollow area and a shelter area The glass substrate is tempered by a chemical tempering process to form a layer retaining compressive stress on the uncovered area of the glass substrate surface so that the patterned layer of compressive stress is formed on the surface of the glass substrate. The patterned layer is formed to at least one surface of the glass substrate. The patterned layer has a plurality of area retaining different surface compressive stress. The patterned layer includes high stress areas separated by a low stress area. The surface compressive stress difference between the areas is larger than 100 MPa, or the depth difference between the areas is larger than 5 μm.

### FIELD OF THE INVENTION

The present invention relates to method for manufacturing a patterned layer of compressive stress on a glass substrate and the glass substrate manufacturing by the method, and particular to a means involving forming a mask having a predetermined pattern on to a substrate. The substrate is tempered by a chemical tempering process to form toughened areas and non-toughened area through the mask.

### DESCRIPTION OF THE PRIOR ART

Common processes for manufacturing tempered glass are thermal tempering process and chemical process. Thermal tempering process is done by heating the glass between the strain point and softening point. The glass is then rapidly cooled below the strain point so as to create a surface layer retaining compressive stress for improving strength of the glass substrate. The chemical process is done by ion exchange through soaking a glass substrate (such as sodium glass substrate) into a liquid (such as molten sylvite) for tempering process so that larger ions (potassium ions) will take the place of the small ions (sodium ions). Such exchange will retain compressive stress into the surface of the substrate for increasing toughness against tensile force.

However, both the processes will toughen the whole glass substrate. The stress retained inside the substrate will increase the difficulty of extra working to the tempered glass such as cutting or splitting. For the tempered glass with the depth of stressed layer over 20 μm and compressive stress over 400 MPa, the flaws caused by the machinery will easily result in shattering. Even the tempered glass is successfully cut, the edge won't be very smooth especially for thick glass substrate.

Accordingly, all the work such as cutting, drilling, and polishing must be done before the tempering process. Such limitation seriously constrains the usage of tempered glass substrate among various panel applications. For example, the manufacture of the panel using tempered glass has to be done unit by unit. The glass has to be cut into pieces according to the specification in advanced, and the circuit layout and related processes can be performed to the pieces. The productivity is then extremely lowered. For the complicated and precise processes of panel manufacturing, such limitation will cause more difficulties and defects to the product.

### SUMMARY OF THE PRESENT INVENTION

Accordingly, the primary object of the present invention is to provide a method for manufacturing a patterned layer of compressive stress on a surface of a glass substrate. Through forming a mask having a predetermined pattern onto the surface of the glass substrate, the glass substrate can be processed by a chemical tempering process to form a patterned surface layer of compressive stress.

To achieve above object, the present invention provides a method to form a patterned layer of compressive stress on a surface of a glass substrate including the following steps. (1) A glass substrate having at least one flat surface on an upper and lower surface thereof. The opposite surface to the at least one flat surface can be a flat or a non-flat surface. The thickness of the glass substrate is preferably smaller than 5 mm. (2) To form a mask having a predetermined pattern. The pattern includes a plurality of hollow area and a shelter area. (3) To perform a chemical tempering process to the glass substrate by soaking the glass substrate with the mask into a bathing tank full of molten tempering liquid for ion exchange operation. Ions on the surface of the glass substrate will be replaced by larger ions of the same valence or larger oxidized ions to form a surface layer retaining compressive stress on the glass substrate uncovered by the mask. (4) To remove the mask from the glass substrate so as to form a desired patterned layer of compressive stress on the glass substrate.

The mask is made of acid-proof rubber which withstands temperature up to 380° C. The rubber material can be silicone, polysulfide. The mask is form to the surface of the glass substrate by stenciling, slot coating, or capillary coating. The mask can also be a rubber thin film attached to the glass substrate. The substrate with the mask can be placed into an oven to bake so as to shape the mask and improve the adherence.

The glass substrate can be a soda-lime glass or various alkali metal aluminosilcate glasses. The tempering liquid can be one or mixture of nitrate, sulfate, alkali metal chloride solution. For example, the soda-lime glass substrate can use a solution of potassium nitrate (KNO₃) for the tempering process.

In a practicable embodiment, a layer of even compressive stress is formed to both upper and lower surface of a glass substrate; the depth of the layer of even compressive stress is less than 20 μm.

The present invention also provides a glass substrate having a patterned layer of compressive stress to form predetermined tempered area and non-tempered area on a surface thereof. The tempered area will improve strength of the glass substrate against splintering and scratching. However, extra work to the glass substrate such as cutting, splitting, and grinding can be performed through the non-tempered area of the glass substrate.

According to the present invention, a patterned layer of compressive stress can be formed to the glass substrate. The patterned layer of compressive stress is formed on at least one surface of the present invention. The patterned layer has a plurality of area of different surface compressive stress. In a practicable embodiment, the patterned layer includes high stress areas separated by a low stress area. The surface compressive stress difference between the areas is larger than 100 MPa, or the depth difference between the areas is larger than 5 μm. The compressive stress of the low stress area is lower than 400 MPa, and is preferably equal to zero or nearly zero. The compressive stress of the high stress area is between 100 MPa to 800 MPa. Or the depth of the low stress area is less than 20 μm, and the depth of the high stress area is between 5 μm to 90 μm. Therefore, the high stress area is tempered so as to be used for transparent substrate or cover for display panels. The low stress area of the glass substrate still remains well capability for performing cutting, splitting, or grinding so that the limitation of the tempered glass for panel manufacture is eliminated and the productivity can be improved as well as the quality.

The glass substrate has at least one flat upper or lower surface, and the opposite surface to the flat surface can be a flat surface or a non-flat surface such as convex, concave, or uneven surface. The substrate is preferably a glass plate with a thickness less than 5 mm. The glass substrate can be a soda-lime glass, aluminosilcate glass, or other material.

Normally, the opposite surface to the surface having the layer of compressive stress has a layer retaining even compressive stress so as to prevent deformation to glass substrate due to stress difference. The layer of even compressive stress is similar to the low stress area which has a depth less than 20 μm.

In another practicable embodiment of the present invention, patterned layers of compressive stress can be formed to both the upper and lower surfaces of the glass substrate, and the patterns on both surfaces can be symmetric or asymmetric.

### BRIEF DESCRIPTION OF THE DRAWINGS

FIG. 1 is a schematic view showing a separated glass substrate and mask of the present invention.

FIG. 2 is a schematic view showing the glass substrate with the mask of the present invention.

FIG. 3 is a front view showing the glass substrate inside a bathing tank and the clamp with a traveler.

FIG. 4 is a side view showing the bathing tank of the present invention.

FIG. 5 is a schematic view showing a finished glass substrate of the present invention.

FIG. 6 is a cross-section view showing the finished glass substrate of the present invention.

FIG. 7 is a compressive stress showing another embodiment of finished glass substrate of the present invention.

FIG. 8 is a schematic view showing a yet embodiment of finished glass substrate of the present invention; and

FIG. 9 is a cross-section view showing the yet embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A glass substrate 1 having larger upper or lower surface is selected in the embodiment. At least one of the upper and lower surfaces is flat, and the opposite surface to the flat surface can be a flat surface or a non-flat surface such as convex, concave, or uneven surface. In the present embodiment, the substrate 1 is a soda lime glass having flat upper and lower surfaces. The thickness of the substrate 1 is about 1 mm.

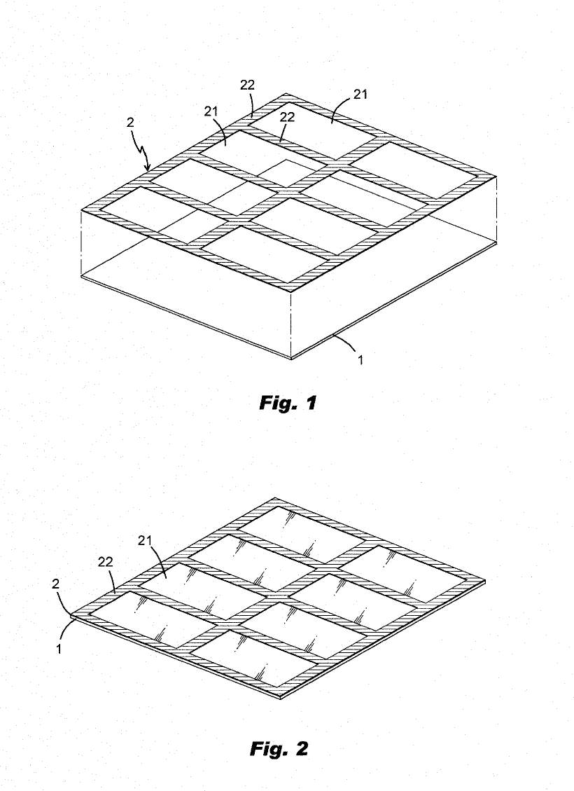

Referring to FIGS. 1 and 2, a mask 2 is arranged to the upper surface of the substrate 1. The mask 2 has a predetermined pattern including a plurality of hollow area 21 and a shelter area 22. The shelter area 22 is tightly attached to the upper surface of the substrate 1. The mask 2 is made of acid-proof silicone which withstands temperature up to 380° C. Molten silicone is stenciled to the substrate 1 so as to form the mask 2. The substrate 1 with the silicone mask 2 is placed into an oven to bake and slowly cooled down to room temperature (about 25° C.) so as to shape the mask 2 and improve the adherence.

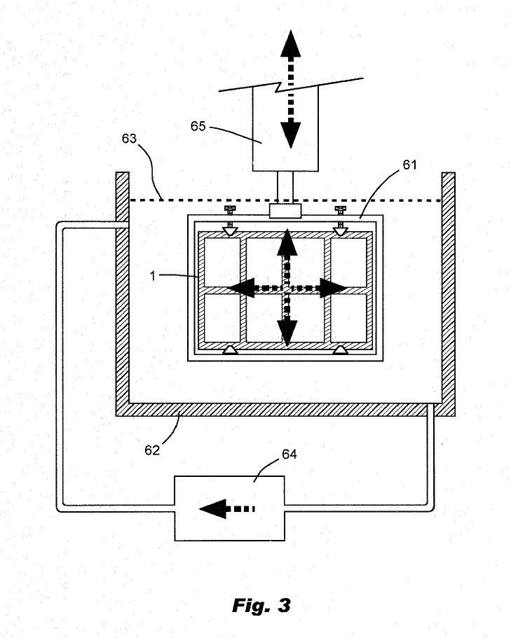

Referring to FIGS. 3 and 4, the chemical tempering process of the substrate 1 is illustrated. The substrate 1 is fixed to a clamp 61 so that the upper and lower surfaces of the substrate 1 are entirely exposed. The clamp 61 is able to moving up and down above a bathing tank 62. The bathing tank 62 is full of 380 to 450° C. molten tempering liquid 63. The substrates for the chemical ion exchange process can be totally soaked under the level of the tempering liquid 63 in the tank 62 during the whole process. In the present embodiment, the tempering liquid 63 for the soda lime glass substrate is a solution of potassium nitrate (KNO₃). Preferably, a cycling filter 64 is arranged inside the bathing tank 62 so as to filter particles and rubbish. The cycling filter 64 could also help to stir the tempering liquid 63 to ensure the uniformity of the tempering liquid 63. The clamp 61 is pivoted to a traveler 65 capable of moving back and forth from up to down, left to right. During the tempering process, the substrate 1 clamped by the clamp 61 is perpendicularly soaked into the bathing tank 62 full of tempering liquid 63. The traveler 65 will drive the clamp 61 to move back and forth from up to down or left to right repeatedly so as to increase the efficiency and uniformity of the ion exchange operation of the tempering process.

During the tempering process, ion exchange operation will happen on the substrate surface within the hollow area 21 of the mask 2. The sodium ions on substrate surface will be exchanged by the potassium ions of the tempering liquid 63. A tempered surface layer retaining compressive stress is thus formed to substrate surface within the hollow area 21 of the mask. However, ion exchange operation will not happen on substrate surface under the shelter area 22 of the mask 2 so that the surface layer can remain the capability of being worked.

The soaking process of the substrate usually takes 0.5 to 7 hours. The depth of the layer of compressive stress is about 10 to 50 μm, and the compressive stress retained is about 200 to 800 MPa.

Obviously, the ion exchange operation involves contents of liquid, temperature, duration, numbers of substrate, using of multiple bathing tanks, or extra steps such as annealing, rinse. Those conditions and steps can be adjusted to control the depth and surface compressive stress of the layer during the tempering process.

The last step of the method of the present invention is to remove the mask 2 attached to the substrate 1 through stripper or polishing. The substrate 1 is finally washed by detergent (or water).

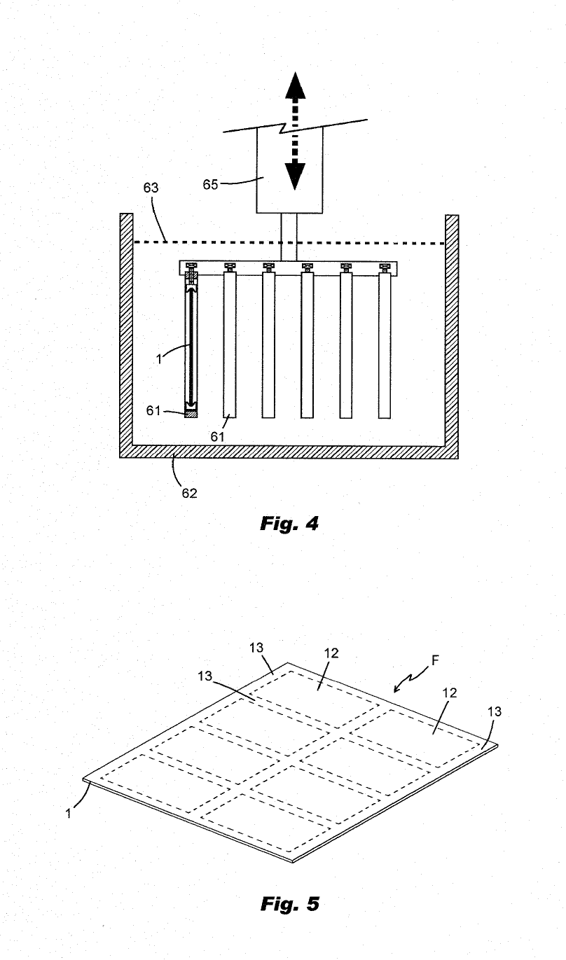

Through above steps, a pattern layer F retaining compressive stress is formed to substrate 1 as shown in FIG. 5. The layer of compressive stress can improve strength of the substrate against splintering and scratching. The rest area of the substrate can still remain well capability for performing cutting, splitting, or grinding. The feature and advantage of the present invention are manifest while the substrate is thinner than 5 mm.

Moreover, the glass substrate 1 can be a tempered glass substrate having a layer of even compressive stress on both upper and lower surface thereof. The depth of the layer of even compressive stress is less than 20 μm. Furthermore, the lower surface of the substrate 1 could be entirely covered by a mask. The lower surface can be entirely exposed to the tempering liquid also so as to form a surface layer of even compressive stress during the ion exchange operation. Besides, the glass substrate with the same mask can have multiple chemical tempering processes. Or, the glass substrate can have multiple chemical tempering processes with different masks so as to form a desired pattern of the layer of compressive stress.

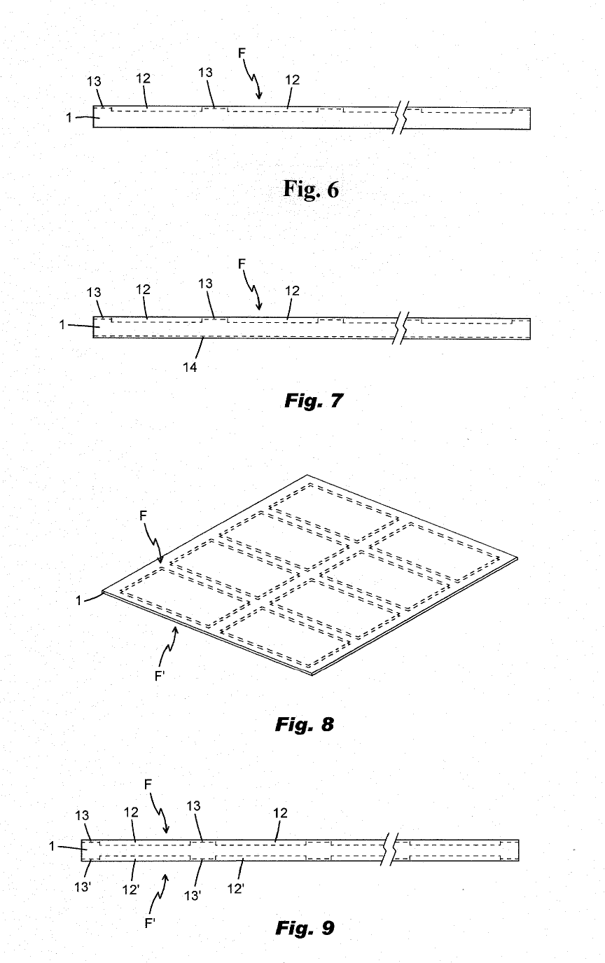

Referring to FIGS. 5 and 6, the compressive stress pattern F in a preferable embodiment is formed to an upper surface of a glass substrate. The compressive stress pattern F includes a plurality of high stress area 12 separated by a low stress areas 13 so that the high stress area 12 (regarded as tempered area) of strength and low stress area 13 (regarded as non-tempered area) reserved for cutting, splitting, or grinding are formed to the surface of the glass substrate. Idealistically, the depth of compressive stress layer of the low stress area 13 is less than 20 μm, and the compressive stress is lower than 400 MPa. The depth of compressive stress layer of the high stress area 12 is between 5 μm to 90 μm, and the compressive stress is between 100 MPa to 800 MPa. Especially, the surface of the glass substrate is separated into high stress areas 12 and low stress areas 13. The stress difference between adjacent areas is larger than 100 MPa, or the depth difference between adjacent areas is larger than 5 μm.

Comparing with known processes of making tempered glass, the tempered glass substrate of the present invention still can be cut, split, or ground. For example, the glass substrate of the present invention can be used for panel production by forming circuit or component within the high stress area and performing extra work within low stress area so that the process limitation of the tempered glass can be eliminated and the yield, productivity can be also improved.

the compressive stress pattern F is formed to the upper surface of the substrate and the opposite lower surface can have a compressive stress layer 14 retaining even stress so as to prevent deformation to glass substrate due to stress difference as shown in FIG. 7. The compressive stress layer 14 is similar to the low stress area 13 with the depth of the compressive stress layer 14 is less than 20p.m.

Referring to FIGS. 8 and 9, another embodiment of the present invention is illustrated. Compressive stress patterns F and F′ are formed to both the upper and lower surfaces of the glass substrate, and the patterns on both surfaces are symmetric. The high stress areas 12 and 12′ of the upper surface and the lower surface respectively are matched, the low stress area 13 and 13′ of the upper surface and the lower surface respectively are matched. The compressive stresses on both surfaces of the glass substrate are balanced so as to prevent deformation. The strength of glass substrate in high stress area will be double improved in the present invention, and the low stress area still remains well capability for extra work.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for manufacturing a patterned layer of compressive stress on a glass substrate comprising:
a. preparing of a glass substrate;
b. forming a mask having a predetermined pattern onto a surface of the glass substrate; the pattern of the mask including a plurality of hollow arca and shelter area;
c. performing a chemical tempering process to the glass substrate by soaking the glass substrate with the mask into a bathing tank full of molten tempering liquid for ion exchange operation; ions on the surface of the glass Substrate being replaced by larger ions of the same valence or larger oxidized ions to form a surface layer retaining compressive stress on the uncovered glass substrate by the mask; and
d. removing the mask from the glass substrate to form a desired patterned layer of compressive stress on the glass substrate.

2. The method for manufacturing a patterned layer of compressive stress on a glass substrate as claimed in claim 1, wherein the glass substrate is one of soda-lime glass or aluminosilcate glass.

3. The method for manufacturing a patterned layer of compressive stress on a glass substrate as claimed in claim 1, wherein at least one of the upper surface or lower surface of the glass substrate is a flat surface; the opposite surface to the flat surface is one of a flat surface or uneven surface.

4. The method for manufacturing a patterned layer of compressive stress on a glass substrate as claimed in claim 3, wherein the thickness of the glass substrate is less than 5 mm.

5. The method for manufacturing a patterned layer of compressive stress on a glass substrate as claimed in claim 1, wherein a layer of even compressive stress is formed to both the upper and lower surface of the glass substrate; the depth of the layer of even compressive stress is less than 20 μm.

6. The method for manufacturing a patterned layer of compressive stress on a glass substrate as claimed in claim 1, wherein the mask is made of acid-proof rubber which withstands temperature up to 380° C.

7. The method for manufacturing a patterned layer of compressive stress on a glass substrate as claimed in claim 6, wherein the rubber is silicone.

8. The method for manufacturing a patterned layer of compressive stress on a glass substrate as claimed in claim 7, wherein the silicone is stenciled to the glass substrate so as to form the mask.

9. The method for manufacturing a patterned layer of compressive stress on a glass substrate as claimed in claim 1, wherein the tempering liquid is one or mixture of nitrate, sulfate, alkali metal chloride solution.

10. The method for manufacturing a patterned layer of compressive stress on a glass substrate as claimed in claim 9, wherein the tempering liquid is a solution of potassium nitrate (KNO₃).

11. A glass substrate having a patterned layer of compressive stress on a surface thereof comprising a patterned layer retaining compressive stress on at least one surface thereof; the patterned layer of compressive stress having a plurality of area including high stress area and low stress area retaining different compressive stresses; the high stress areas being separated by lower stress areas; the surface compressive stress difference between areas being larger than 100 MPa; and
wherein both the upper and lower surface of the glass substrate have a patterned layer of compressive stress; and
wherein the patterned layers on the upper and lower surfaces of the glass substrate are matched.

12. The glass substrate having a patterned layer of compressive stress on a surface thereof as claimed in claim 11, wherein the surface compressive stress retained in the low stress area is less than 400 MPa.

13. The glass substrate having a patterned layer of compressive stress on a surface thereof as claimed in claim 11, wherein the surface compressive stress retained in the high stress area is between 100 MPa to 800 MPa.

14. The glass substrate having a patterned layer of compressive stress on a surface thereof comprising a patterned layer retaining compressive stress on at least one surface thereof; the patterned layer of compressive stress having a plurality of high stress area separated by lower stress area; the high stress area and the low stress area having different depths of the layer of compressive stress, and the depth difference between the high stress area and the low stress area being larger than 5 μm.

15. The glass substrate having a patterned layer of compressive stress on a surface thereof as claimed in claim 14, wherein the depth of the layer of compressive stress of the low stress area is less than 20 μm.

16. The glass substrate having a patterned layer of compressive stress on a surface thereof as claimed in claim 14, wherein the depth of the layer of compressive stress of the high stress area is between 5 μm to 90 μm.

17. The glass substrate having a patterned layer of compressive stress on a surface thereof us claimed in claim 11, wherein at least one of the upper surface or lower surface of the glass substrate is a flat surface; the opposite surface of the flat surface is one of a flat surface or uneven surface.

18. The glass substrate having a patterned layer of compressive stress on a surface thereof as claimed in claim 17, wherein the upper and lower surfaces of the glass substrate are flat surfaces and the thickness of the glass substrate is less than 5 mm.

19. The glass substrate having a patterned layer of compressive stress on a surface thereof as claimed in claim 11, wherein the glass substrate is one of soda-lime glass or aluminosilcate glass.

20. The glass substrate having a patterned layer of compressive stress on a surface thereof as claimed in claim 11, wherein a layer of even compressive stress is formed to the opposite lower surface of the glass substrate; and
wherein the depth of the layer of even compressive stress is less than 20 μm.

21-23. (canceled)
